(19) United States
(12) Patent Application Publication
(10) Pub. No.: US 2025/0377208 A1
(43) Pub. Date: Dec. 11, 2025

(54) DATA LAYER AUGTMENTATION

(71) Applicant: AUTOBRAINS TECHNOLOGIES LTD, Tel Aviv-Yafo (IL)

(72) Inventors: Maya RAPAPORT, Tel Aviv-Yafo (IL); Max MONASTIRSKY, Tel Aviv-Yafo (IL)

(73) Assignee: AUTOBRAINS TECHNOLOGIES LTD, Tel Aviv-Yafo (IL)

(21) Appl. No.: 18/739,321

(22) Filed: Jun. 11, 2024

(51) Int. Cl. G01C 21/32

(52) U.S. Cl. CPC G01C 21/32

(57) ABSTRACT

A method that is computer implemented and is for data layer augmentation, the method includes obtaining, by a processor associated with a vehicle, a data layer associated with road elements of a specified type; obtaining, by a processor associated with a vehicle, localization information regarding a location of the vehicle, wherein the road element information is obtained based on aerial image information within a region of a vehicle and on environmental information sensed by the vehicle; and augmenting the data layer using the localization information, wherein the augmenting of the data layer comprises populating a database with data representing updated road elements location for a group of road elements of the specified type within the region of the vehicle.

### BACKGROUND

Vehicle environment information is critical for systems relating to the autonomous driving of ground autonomous vehicles (AVs). Such vehicle environment information may include, for example, the location of the ground vehicle, which is used for planning a next driving operation of the ground vehicle, for navigating the ground vehicle, for determining applicable driving laws, and the like.

The location of the ground vehicle should be accurate, should be updated frequently, should be easily accessible by an AV system of the ground vehicle, and should be highly secure.

Current localization solutions rely on maps produced, for example, by ground image capture, and city/street planning information. These maps may be constantly updated based on inputs provided by multiple ground vehicles. These solutions require that the locations determined using the high-definition map be driven by many ground vehicles, and in some instances, only by the same type of ground vehicle. These solutions also depend on the existence of predetermined landmarks at the current location of the ground vehicle, and some locations may not be associated with these landmarks.

There is a growing need to provide an accurate and efficient method for locating the ground vehicle without having a predetermined high-definition map that includes landmarks identified from images sensed by other ground vehicles.

### SUMMARY

There is provided a method, a non-transitory computer readable medium and a system as illustrated in the specification.

### BRIEF DESCRIPTION OF THE DRAWINGS

The embodiments of the disclosure will be understood and appreciated more fully from the following detailed description, taken in conjunction with the drawings in which:

FIGS. 1A-1C are schematic diagrams of a system for determining a vehicle location and system components according to embodiments of the disclosure;

FIG. 2 illustrates a ground vehicle and a plurality of vehicle sensors present in the ground vehicle;

FIGS. 3A-3G illustrate examples of an aerial image segments, a vehicle image segments, and corresponding heatmaps according to embodiments of the disclosure;

FIG. 4 illustrates an example of an initial fusion result according to embodiments of the disclosure;

FIG. 5 is a flow diagram of a method for determining a vehicle location according to embodiments of the disclosure;

FIG. 6 is a block diagram of a computer according to an aspect of the present disclosure;

FIG. 7 illustrates an example of a method;

FIG. 8A illustrates an example of a vehicle;

FIG. 8B illustrates an example of a vehicle;

FIG. 8C illustrates an example of a vehicle;

FIG. 9A illustrates an example of a method;

FIG. 9B illustrates an example of a step of the method of FIG. 9A;

FIG. 9C illustrates an example of a step of the method of FIG. 9A;

FIG. 9D illustrates an example of a step of the method of FIG. 9A;

FIG. 10A illustrates an example of a method; and

FIG. 10B illustrates an example of one or more memory/storage units 120A.

### DETAILED DESCRIPTION

Any reference to zero shot learning should be applied mutatis mutandis to one shot learning and/or to a few shot learning.

Zero-shot learning is a machine learning paradigm where a model is trained to recognize classes it has never seen during training. In traditional supervised learning, models are trained on labeled data from all classes they are expected to recognize. However, in zero-shot learning, the model is trained to generalize its understanding of features to unseen classes.

One-shot learning and few-shot learning are techniques used in machine learning and computer vision to address the challenge of training models with limited labeled data. These approaches aim to enable the classification of new classes or objects with only a small number of examples, or even just a single example.

One-shot learning refers to the ability of a model to recognize and classify new objects or classes based on a single example. Traditional machine learning algorithms typically require a large amount of labeled data to train a model effectively. However, in real-world scenarios, obtaining a large number of labeled examples for every possible class or object may be impractical or time-consuming. One-shot learning techniques aim to overcome this limitation by leveraging the similarities and differences between classes to generalize from a single example.

To achieve one-shot learning, models often employ techniques such as metric learning, where the model learns to measure the similarity between examples. By comparing the features extracted from the single example to a set of known examples, the model can make predictions about the class or category of the new object. This approach relies on the assumption that objects from the same class will have similar features or characteristics.

Few-shot learning extends the concept of one-shot learning by allowing models to classify new classes or objects with a small number of examples, typically ranging from a few to a few dozen. This approach recognizes that while obtaining a single example may be challenging, acquiring a small number of examples for each class is more feasible in many cases.

In few-shot learning, models are trained to learn from a limited number of labeled examples per class. This involves leveraging transfer learning techniques, where knowledge gained from training on a large dataset is transferred to the few-shot learning task. The model learns to generalize from the limited examples by capturing the underlying patterns and similarities between classes.

To improve few-shot learning performance, various techniques have been developed, including meta-learning and episodic training. Meta-learning involves training a model on multiple few-shot learning tasks, allowing it to learn how to learn from limited examples effectively. Episodic training involves creating episodes or mini-batches during training, where each episode consists of a few examples from different classes. This helps the model learn to generalize across classes and adapt to new classes with limited examples.

Both one-shot learning and few-shot learning have significant implications in various domains, including computer vision, natural language processing, and robotics. These techniques enable models to quickly adapt to new classes or objects, making them more flexible and applicable in real-world scenarios where labeled data may be scarce or expensive to obtain.

Accordingly, one-shot learning and few-shot learning techniques provide solutions to the challenge of training models with limited labeled data. By leveraging similarities and patterns between classes, these approaches enable models to classify new objects or classes with only a single or a few examples. These techniques have the potential to revolutionize machine learning applications by enabling models to learn and adapt quickly to new information, even in data-scarce environments.

A representative vector represents an element selected of an object or a road scenario. The element was captured by a sensed information unit. The representative vector may be generated based on a cropped sensed information unit.

The different figures illustrates examples of units and/or software and/or information items and/or steps and/or components. These examples are provided for brevity of explanation. At least one of the units and/or software and/or information items and/or steps and/or components is optional or mandatory.

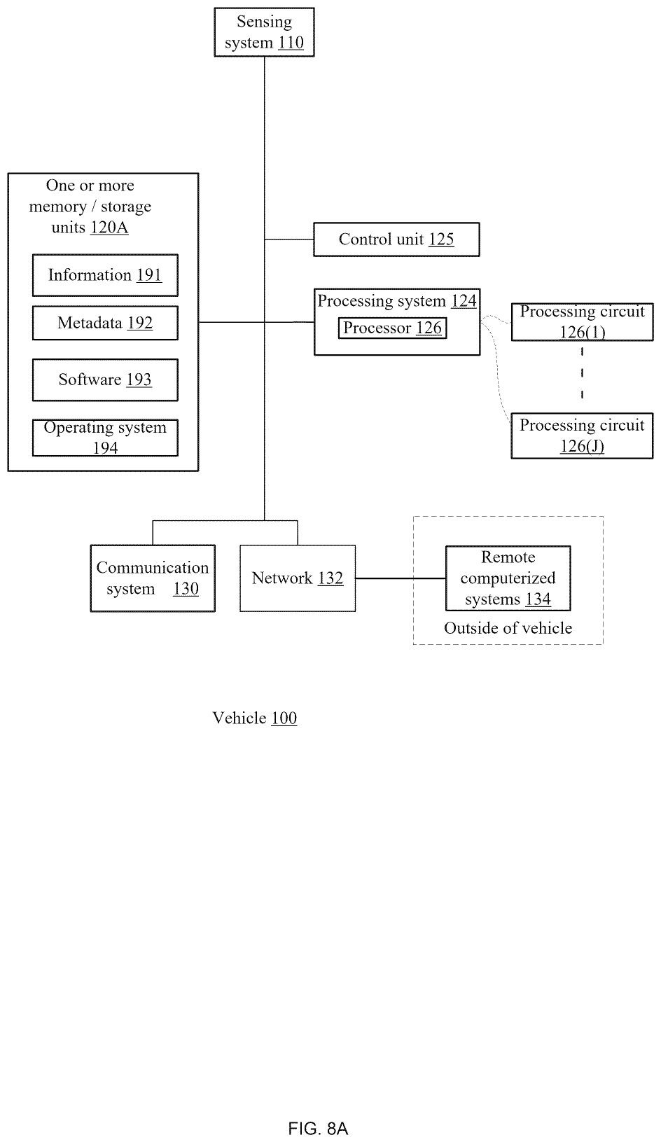

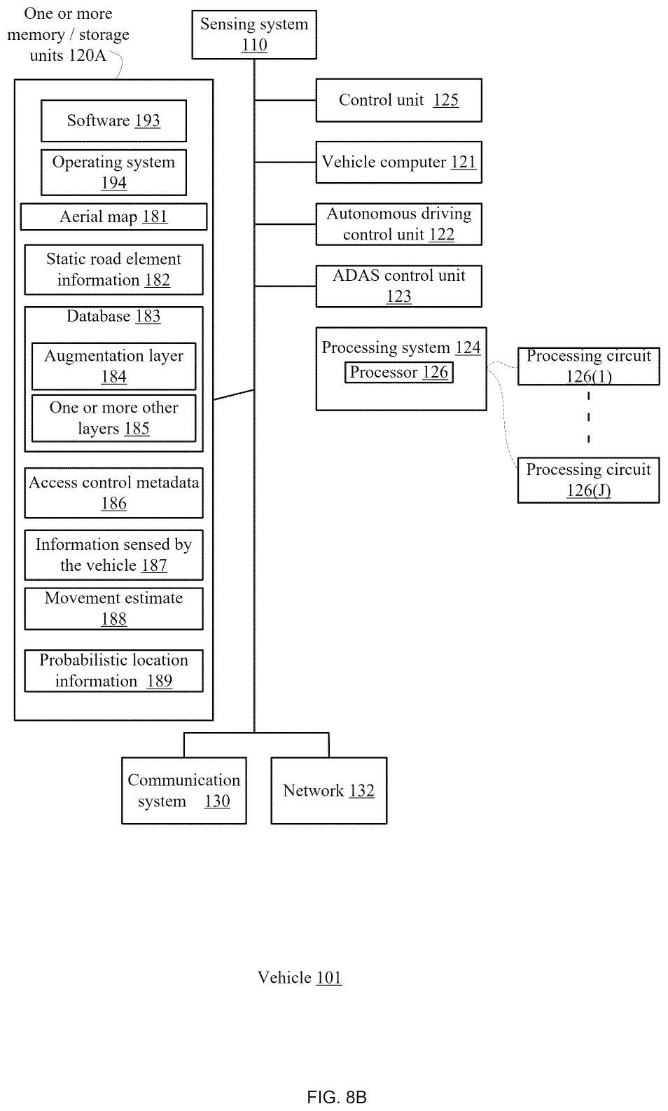

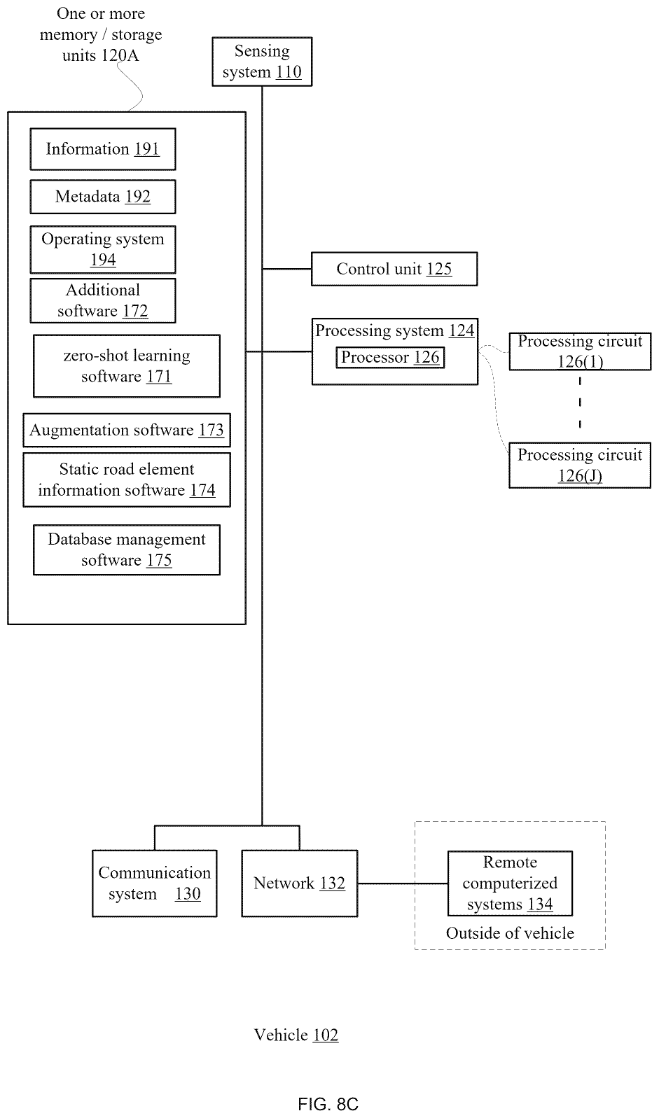

FIGS. 8A-8C illustrate examples of vehicles 100, 101 and 102 respectively, network 123 and remote computerized systems 134.

The vehicle 100 includes (a) sensing system 110, a communication system 130, one or more memory and/or storage units 120A, and additional units that include control unit 125 (in FIGS. 8B and 8C there are also a vehicle computer 121, and advanced driver assistance system (ADAS) control unit 123, autonomous driving control unit 122), processing system 124 including processor 126. Network 123 is in communication with the vehicle and with the remote computerized systems 134 such as servers, cloud computers, and the like.

Communication system 130, one or more memory and/or storage units 120A, and processing system 134 may form a computerized system. The computerized system may include one or more other systems and/or units such as sensing system 110.

The communication system 130 is configured to enable communication between the one or more memory and/or storage units 120A and/or the sensing system 110 and/or any one of the additional units and/or the network 132 (that is in communication with the remote computerized systems).

The control unit 125 is configured to control various operations related to the vehicle-such as but not limited to various steps of method 600.

The one or more memory and/or storage units 120A are illustrated as storing an operating system 194, software 193 (especially software required to execute method 200), information 191 and metadata 192 (especially information and metadata required to execute method 200). The information may include environmental information. The metadata may include any metric or an outcome of processed information-especially related to the execution of method 200.

Vehicle 101 of FIG. 8B and vehicle 102 of FIG. 8C differ from vehicle 100 of FIG. 8A by including more examples of content stored in the one or more memory and/or storage units 120A.

The sensing system 110 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 110 is configured to output one or more sensed information units (SIUs).

The communication system 130 is configured to enable communication between the one or more memory and/or storage units 120A and/or the sensing system 110 and/or any one of the additional units and/or the network 132 (that is in communication with the remote computerized systems).

The controller 125 is configured to control the operation of the sensing system 110, and/or the one or more memory and/or storage units 120A and/or the one or more additional units (except the controller).

The ADAS control unit 123 is configured to control ADAS operations.

The autonomous driving control unit 122 is configured to control autonomous driving of the autonomous vehicle.

The vehicle computer 121 is configured to control the operation of the vehicle-especially controlling the engine, the transmission, and any other vehicle system or component.

The processing system 124 may include processor 146 and one or more other processors and is configured to execute any method illustrated in the specification.

The one or more memory and/or storage units 120A are configured to store firmware and/or software, one or more operating systems, data and metadata required to the execution of any of the methods mentioned in this application.

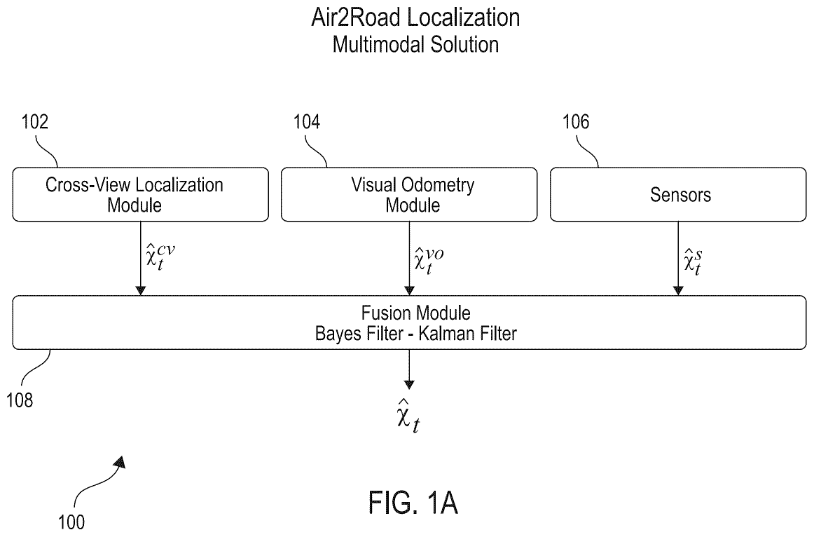

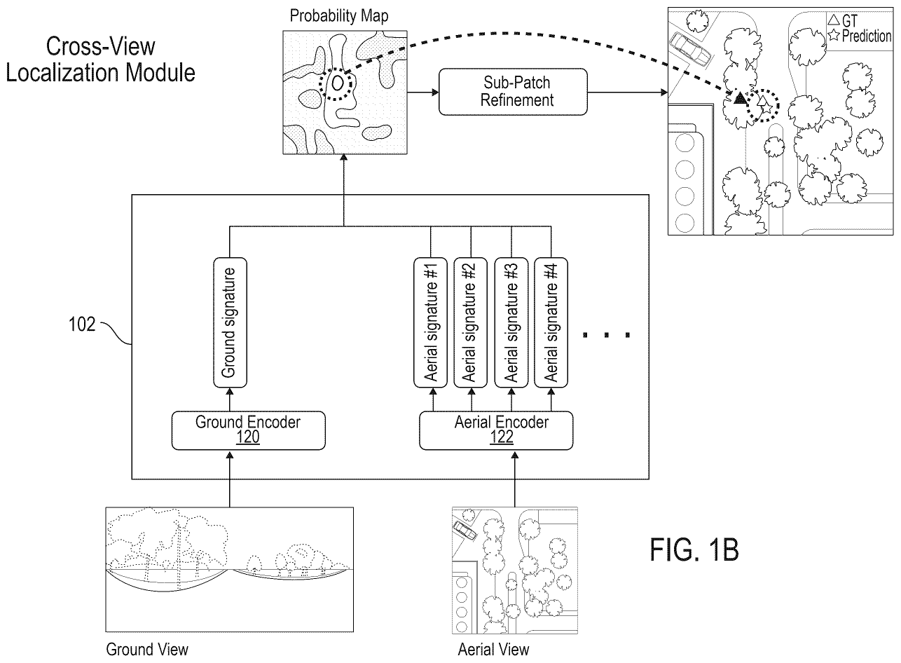

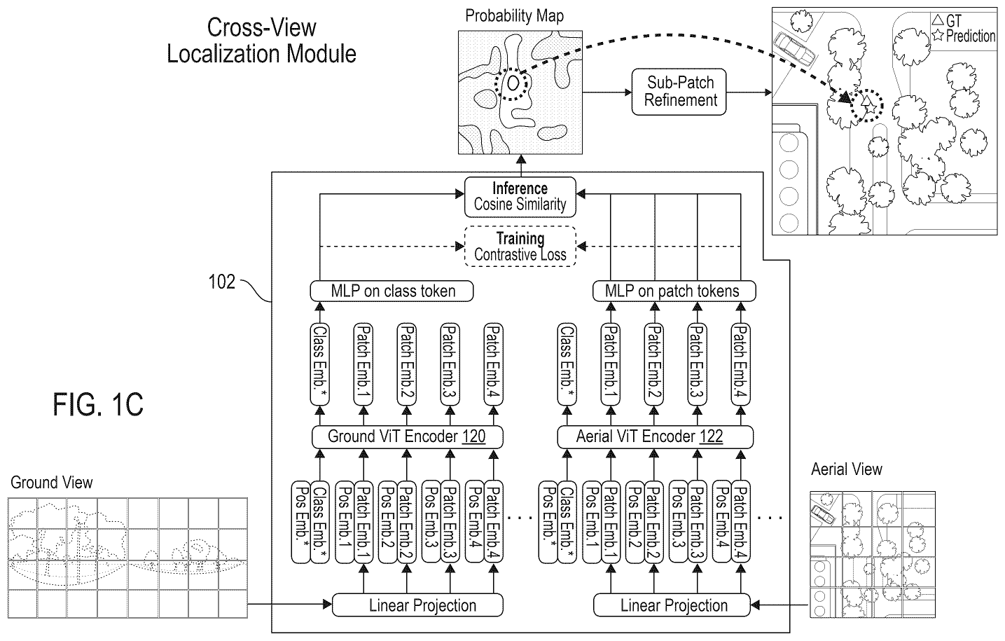

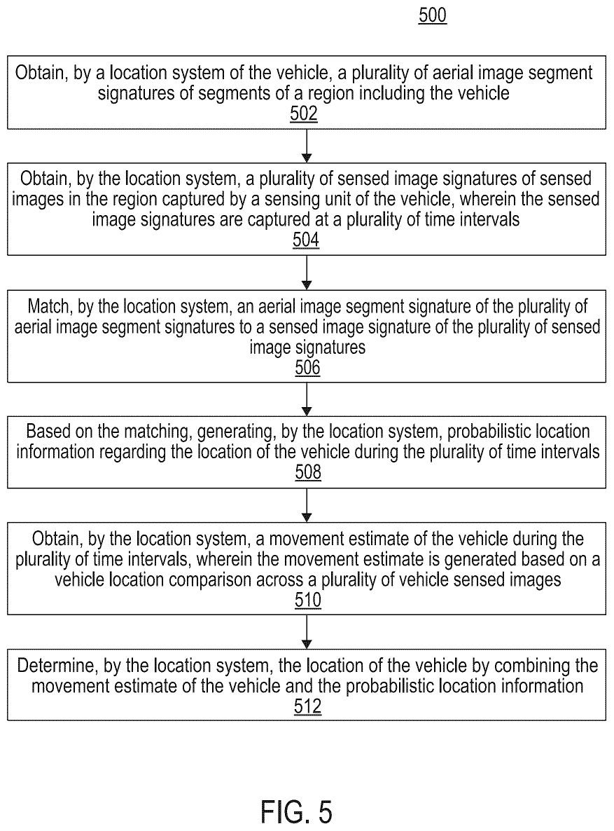

FIGS. 8B and/or FIG. 8C illustrate the one or more memory and/or storage units 120A as storing at least some of:
Aerial map 181.
Static road element information 182.
Database 183 that may store the aerial map (in one or more layers 185) and augmented information (including the static road element information) within augmentation layer 184 (or not within a dedicated augmentation layer).
Access control metadata 186 for controlling access to the database 183.
Information sensed by the vehicle 187.
Movement estimate 188 that may be generated by a visual odometry module.
Probabilistic location information 189.
Zero-shot learning software 171.
Static road element information software 174 for generating the Static road element information 182.
Database management software 175 configured to augment the aerial map and/or to control a transmission of the content of the database and/or for access control.
Operating system 194.
Additional software 172 that may be used to perform any other functionality of the vehicle and/or of any of the other units illustrated in FIGS. 1A-1C and 5.

The vehicle computer 121 may be in communication with an engine control module, a transmission control module, a powertrain control module, and the like

The memory and/or storage units 120A was shown as storing software. Any reference to software should be applied mutatis mutandis to code and/or firmware and/or instructions and/or commands, and the like.

Processor 126 includes a plurality of processing units 126(1)-126(J), J is an integer that exceeds one. Any reference to one unit or item should be applied mutatis mutandis to multiple units or items. For example—any reference to processor should be applied mutatis mutandis to multiple processors, any reference to communication system 130 should be applied mutatis mutandis to multiple communication systems.

According to an embodiment, the one or more memory and/or storage units 120A includes one or more memory unit, each memory unit may include one or more memory banks.

According to an embodiment, the one or more memory and/or storage units 120A includes a volatile memory and/or a non-volatile memory. The one or more memory and/or storage units 120A may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database-such as any database known in the art-such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 130. Other communication elements may be provided.

FIGS. 8A-8C illustrate communication system 130 as being in communication with various processors and/or units and network 132.

The communication system 130 may include a bus. The represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 132 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 130) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 120A may be stored outside the vehicle-fir example database 193 or any part thereof may be stored outside the vehicle. It should also be noted that the processor may evaluate signatures generated by a plurality of detectors.

According to an embodiment, the processor is configured to perform at least one of the following:
Obtain static road element information regarding a location of static road elements within a region. The static road information is obtained by applying zero-shot learning based on information sensed by a vehicle.
Augment the aerial map using the static road element information, wherein the augmenting of the aerial map comprises populating a database.
Respond to the updating—for example by granting access to the database to defined entities and/or by delivering the populated database as a downable software to a recipient.

According to an embodiment, the static road information is based on a movement estimate of a road vehicle and on probabilistic location information indicative a location of the road vehicle within the aerial map. Examples of the movement estimate and of the probabilistic location information are illustrated in FIGS. 1A-1C, 2, 3A-3G, and 5—(for example—the visual odometry module 104, the probability map, probabilistic location information 228, motion information 226, localization probability heatmaps 308, 312, 318, 324, 330, 336, 342). The probabilistic location information is based on the aerial map. The probabilistic location information and the movement estimate provide a highly accurate location of the vehicle—that is also aligned with the aerial map.

Accordingly—the location of the static road elements generated based on information sense by the vehicle is also aligned with the aerial map.

According to an embodiment, the processor is configured to obtain the static road element information by at least one of the following:
Receive the information sensed by a vehicle.
Process the information referred to as the information sensed by the vehicle.
Generate the static road information by applying zero-shot learning.
Receive the static road information. For example-retrieve the static road information, store the static road information, access a local or remote memory unit to obtain the static road information.
Adding static road element information about a static road element that is absent from the aerial map.
Replace static road element information about a static road element that is absent from the aerial map.
Augment the aerial map using static road element information being in relevancy to a driving path of the vehicle. For example-more weight is assigned to static road elements that are proximate to the driving path of the vehicle—for example, within 1-20 meters from the driving path. According to an embodiment, there may be provided different distance ranges related to distances of static road elements from the driving path—and the different distance ranges are associated with different weights.
Selectively augment the aerial map based on one or more rules—such as: (i) allocate weight to static road element information based on a time that the static road element information was generated (especially the time difference between the generation of the aerial map and the last generated static road element information), (ii) allocate weight to static road element information based on a number of vehicles that reported the presence of the static object, (iii) allocate weight to static road element information based on a confidence level associated with at least one of the aerial map and the static road element information. The confidence level may be generated in various manners—for example by a computerized entity that generated the static road element information. The confidence level may be dependent on one or more parameters such as signal to noise of the information sensed by the vehicle, success rates of the zero-shot learning process, sensing information acquisition parameters (for example-quality or intensity of illumination weather conditions). The confidence level may be based verification or triangulation of the location of the static road element—for example-a higher confidence level may be assigned when the static road element information is generated by sensed information obtained by the vehicle in which the static road element is sensed from different angles (while the vehicle moved in relation to the static road element)—or when the vehicle verifies the location of the static road element based on sensed information obtained by the vehicle in which the static road element is sensed from different angles. (iv) Update the aerial map when the weight assigned to the static road element information exceed by at least a predefined amount the weight assigned to the aerial map. (v) Apply a hysteresis that imposes a minimum time between consecutive updates of the aerial map to reduce the rate of successive aerial map updates. (iv) updating the aerial map based on resource constraints—for example memory constraints, communication constraints and/or processing resource constraints.
Populate an augmentation layer of the aerial map with the static road element information. The aerial map (without the augmentation) may be stored in one or more other layers of the database.

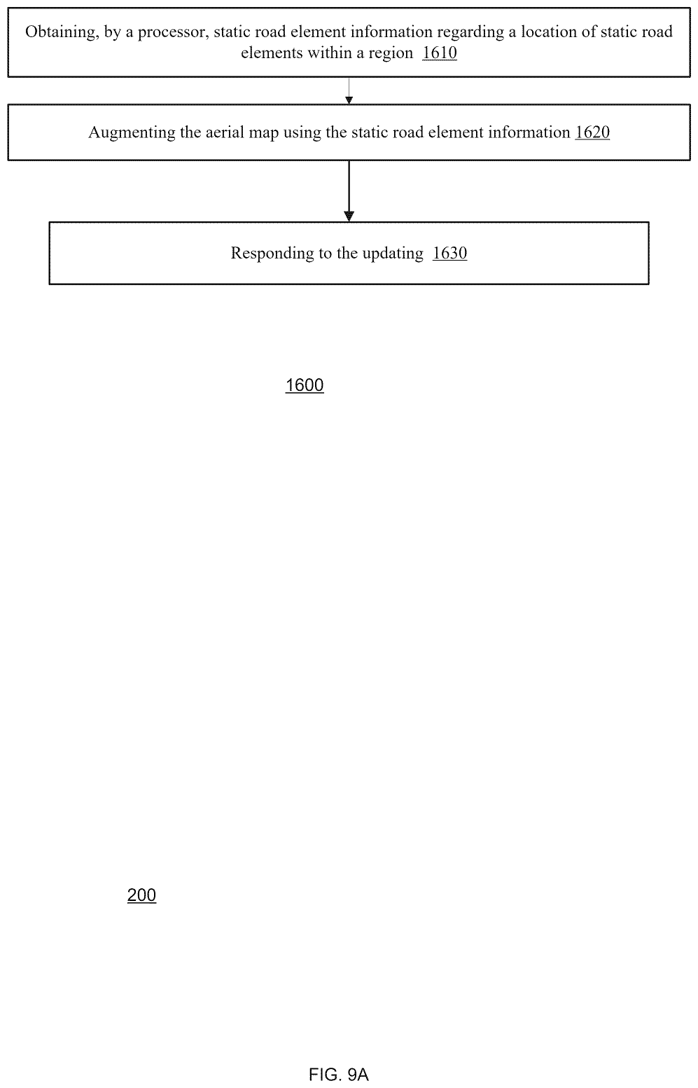

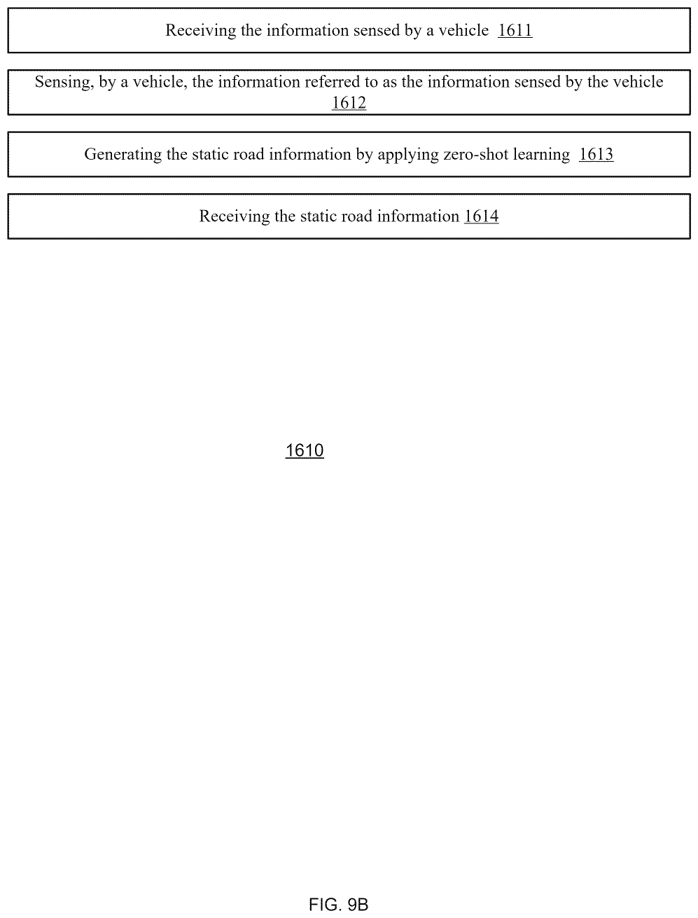

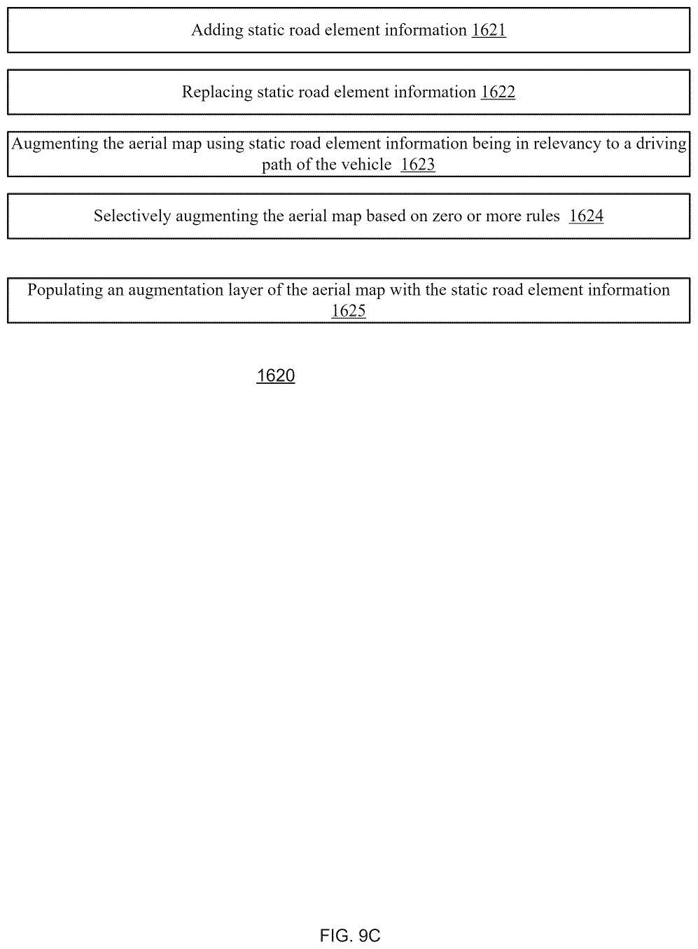

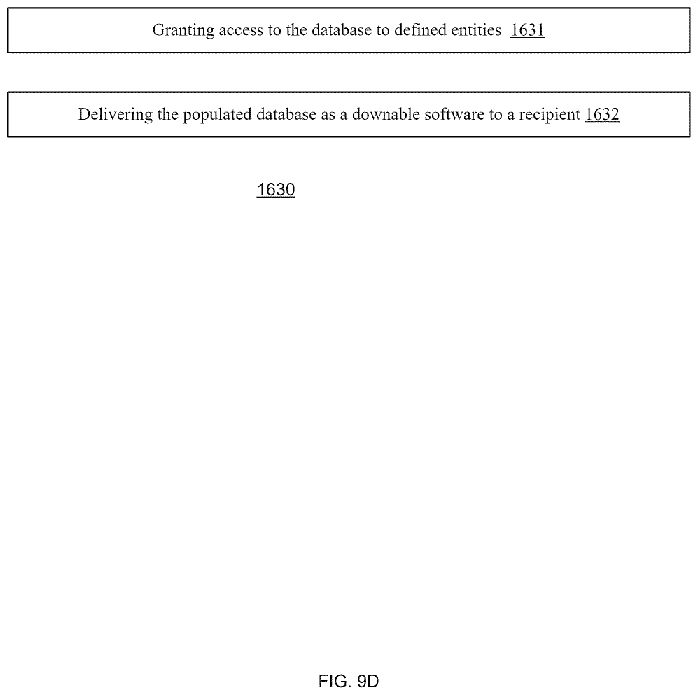

FIG. 9A illustrates an example of method 1600 for augmenting an aerial map.

FIG. 9B illustrates an example of step 1610 of method 1600.

FIG. 9C illustrates an example of step 1620 of method 1600.

According to an embodiment, method 1600 includes step 1610 of obtaining, by a processor, static road element information regarding a location of static road elements within a region. The static road information is obtained by applying zero-shot learning based on information sensed by a vehicle.

According to an embodiment, the static road information is based on a movement estimate of a road vehicle and on probabilistic location information indicative a location of the road vehicle within the aerial map. Examples of the movement estimate and of the probabilistic location information are illustrated in FIGS. 1A-1C, 2, 3A-3G, and 5—(for example—the visual odometry module 104, the probability map, probabilistic location information 228, motion information 226, localization probability heatmaps 308, 312, 318, 324, 330, 336, 342). The probabilistic location information is based on the aerial map. The probabilistic location information and the movement estimate provide a highly accurate location of the vehicle—that is also aligned with the aerial map.

Accordingly—the location of the static road elements generated based on information sense by the vehicle is also aligned with the aerial map.

According to an embodiment, step 1610 includes at least one of (see FIG. 9B):
Receiving the information sensed by a vehicle (1611).
Sensing, by a vehicle, the information referred to as the information sensed by the vehicle (1612).
Generating the static road information by applying zero-shot learning (1613). Step 1613 may include applying the zero-shot learning based on information sensed by a vehicle.
Receiving the static road information (1614). Step 1614 may include retrieving the static road information, storing the static road information, accessing a local or remote memory unit to obtain the static road information.

According to an embodiment, step 1610 is followed by step 1620 of augmenting the aerial map using the static road element information, wherein the augmenting of the aerial map comprises populating a database.

According to an embodiment, step 1620 includes at least one of (see FIG. 9C):
Step 1621 of adding static road element information about a static road element that is absent from the aerial map.
Step 1622 of replacing static road element information about a static road element that is absent from the aerial map.
Step 1623 of augmenting the aerial map using static road element information being in relevancy to a driving path of the vehicle. For example—more weight is assigned to static road elements that are proximate to the driving path of the vehicle—for example, within 1-20 meters from the driving path. According to an embodiment, there may be provided different distance ranges related to distances of static road elements from the driving path—and the different distance ranges are associated with different weights.
Step 1624 of selectively augmenting the aerial map based on one or more rules—such as:
   i. Weight can be allocated to static road element information based on a time that the static road element information was generated (especially the time difference between the generation of the aerial map and the last generated static road element information).
   ii. Weight is allocated to static road element information based on a number of vehicles that reported the presence of the static object.
   iii. Weight is allocated to static road element information based on a confidence level associated with at least one of the aerial map and the static road element information. The confidence level may be generated in various manners—for example by a computerized entity that generated the static road element information. The confidence level may be dependent on one or more parameters such as signal to noise of the information sensed by the vehicle, success rates of the zero-shot learning process, sensing information acquisition parameters (for example—quality or intensity of illumination weather conditions). The confidence level may be based verification or triangulation of the location of the static road element—for example-a higher confidence level may be assigned when the static road element information is generated by sensed information obtained by the vehicle in which the static road element is sensed from different angles (while the vehicle moved in relation to the static road element)—or when the vehicle verifies the location of the static road element based on sensed information obtained by the vehicle in which the static road element is sensed from different angles.
   iv. Updating the aerial map when the weight assigned to the static road element information exceed by at least a predefined amount the weight assigned to the aerial map.
   v. Applying a hysteresis that imposes a minimum time between consecutive updates of the aerial map to reduce the rate of successive aerial map updates.
   vi. Updating the aerial map based on resource constraints—for example memory constraints, communication constraints and/or processing resource constraints.
Step 1625 of populating an augmentation layer of the aerial map with the static road element information. The aerial map (without the augmentation) may be stored in one or more other layers of the database.

According to an embodiment, the database is stored within a memory unit of the vehicle.

According to an embodiment, the database is stored outside the vehicle.

According to an embodiment, step 1620 is followed by 1630 of responding to the updating.

According to an embodiment, the database is access controlled and step 1630 includes step 1631 of granting access to the database to defined entities. The defined entities may include other drivers, database users, and the like.

According to an embodiment, step 1630 includes step 1632 of delivering the populated database as a downable software to a recipient.

There is provided a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

There is provided a method for determining a location of a vehicle. The method also includes obtaining, by a processor, a plurality of aerial image segment signatures of segments of a region including the vehicle. The method also includes obtaining, by the processor, a plurality of sensed image signatures associated with the region including the vehicle. The method also includes matching, by the processor, a selected aerial image segment signature of the plurality of aerial image segment signatures to a selected sensed image signature of the plurality of sensed image signatures. The method also includes based on the matching step, generating, by the processor, probabilistic location information regarding the location of the vehicle. The method also includes generating, by the processor, a movement estimate of the vehicles, where the movement estimate is generated based on a vehicle location comparison across a plurality of vehicle sensed images, where the plurality of vehicle sensed images are captured at a plurality of time intervals. The method also includes determining, by the processor, the location of the vehicle by combining the movement estimate of the vehicle and the probabilistic location information. Other embodiments of this aspect include corresponding computer systems, apparatus, and computer programs recorded on one or more computer storage devices, each configured to perform the actions of the methods.

There is provided a non-transitory computer readable medium for determining a location of a vehicle. The non-transitory computer readable medium also stores instructions for obtaining a plurality of aerial image segment signatures of segments of a region including the vehicle. The medium also stores instructions for obtaining a plurality of sensed image signatures associated with the region including the vehicle. The medium also stores instructions for matching a selected aerial image segment signature of the plurality of aerial image segment signatures to a selected sensed image signature of the plurality of sensed image signatures. The medium also stores instructions for generating, based on the matching step, probabilistic location information regarding the location of the vehicle. The medium also stores instructions for generating a movement estimate of the vehicles, where the movement estimate is generated based on a vehicle location comparison across a plurality of vehicle sensed images, where the plurality of vehicle sensed images are captured at a plurality of time intervals. The medium also stores instructions for determining the location of the vehicle by combining the movement estimate of the vehicle and the probabilistic location information. Other embodiments of this aspect include corresponding computer systems, apparatus, and computer programs recorded on one or more computer storage devices, each configured to perform the actions of the methods.

One general aspect includes a location system of a vehicle. The location system also includes one or more processing circuits that may include at least a part of an integrated circuit. The system is also configured to obtain a plurality of aerial image segment signatures of segments of a region including the vehicle. The system is also configured to obtain a plurality of sensed image signatures associated with the region including the vehicle. The system is also configured to match a selected aerial image segment signature of the plurality of aerial image segment signatures to a selected sensed image signature of the plurality of sensed image signatures. The system is also configured to, generate based on the matching step, probabilistic location information regarding the location of the vehicle. The system is also configured to generate a movement estimate of the vehicles, where the movement estimate is generated based on a vehicle location comparison across a plurality of vehicle sensed images, where the plurality of vehicle sensed images are captured at a plurality of time intervals. The system is also configured to determine the location of the vehicle by combining the movement estimate of the vehicle and the probabilistic location information. Other embodiments of this aspect include corresponding computer systems, apparatus, and computer programs recorded on one or more computer storage devices, each configured to perform the actions of the methods.

According to embodiments of the disclosure, systems, non-transitory computer readable medium, and methods for determining a location of a vehicle are provided. According to embodiments of the disclosure, the systems, non-transitory computer readable medium and methods do not rely on predetermined high-definition maps that include landmarks identified from images sensed by other ground vehicles, or other previously acquired location information. Instead, location information is gathered in real-time from at least two sources and combined to provide highly accurate vehicle location information while the vehicle is in motion.

Referring now to the drawings, FIGS. 1A-1C are schematic diagrams of a system 100 for determining a vehicle location according to embodiments of the disclosure. As shown in FIG. 1A, the system 100 may include a cross-view localization module 102, a visual odometry module 104, a sensor module 106, and a fusion module 108.

Inputs into the system 100, or one or more system components, may include aerial images 216, aerial image segment signatures 218, vehicle sensed images 220 (at least some of which are acquired at different points in time), vehicle sensed image signatures 222, movement estimates 224, motion information 226, and a probabilistic location information 228, each of which shall be discussed in greater detail herein. For instance, inputs may include an image from the vehicle (for example, a 360-degree surround view image taken by a front camera of the vehicle), a satellite image, a GPS signal, and any additional information such as velocity from controller area network (CAN) signals and/or an inertial measurement unit (IMU).

Inputs may be processed by the cross-view localization module 102. FIG. 1B is a schematic diagram of the cross-view localization module 102 of FIG. 1A. The cross-view localization module 102 is configured to obtain a plurality of sensed images from, for example, a sensing unit of the vehicle and is further configured to receive a plurality of aerial images or image segments from, for example a satellite feed.

As is further illustrated in FIG. 1B, the cross-view localization module 102 is configured to obtain a plurality of aerial images or aerial image segments. According to embodiments of the disclosure, the cross-view localization module 102 may be configured to receive a plurality of aerial images or image segments of a region in which the vehicle is located. To this end, the cross-view localization module 102 is configured to receive a plurality of inputs from one or more outside-the-vehicle sources. Outside-the-vehicle sources may include satellite images or GPS location information.

A coverage area (i.e., a specified image capture area) for a captured aerial image segment may be determined. The required coverage area of a specified image capture area may be determined in advance or in a dynamic manner. For example, if the ground vehicle is located in an urban area, or another area that exhibits a high density of objects, then the aerial image coverage area may be reduced. Alternatively, if the ground vehicle is located in a rural, desolate, isolated or other area only sparsely populated with objects, then the aerial image coverage area may be increased. Modifications to the coverage area may be assisted by coarse location information of the ground vehicle. Such coarse location information may be received from, for example, by as a global positioning satellite (GPS) system, a cellular location system, and the like.

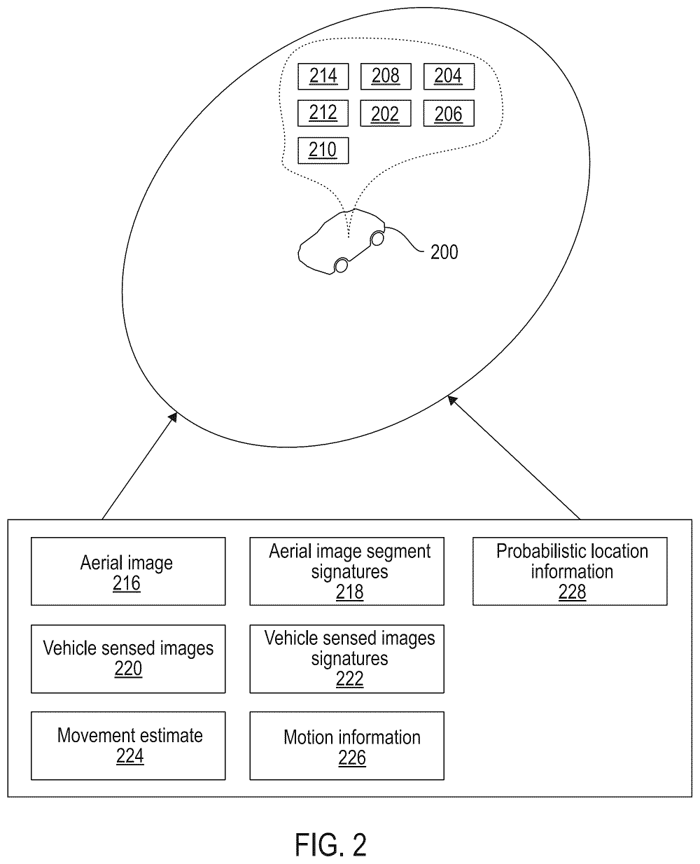

The cross-view localization module 102 is further configured to receive a plurality of sensed images. To this end, the system 100 is configured to receive a plurality of sensed inputs from one or more in-vehicle sources. FIG. 2 illustrates a ground vehicle 200 including a plurality of components. According to embodiments of the disclosure, a ground vehicle 200 including the location system 100 as described herein may include a vehicle sensing unit 202 that further includes one or more sensors such as vehicle sensors 204 and 206. The vehicle sensors 204, 206 may include multiple image sensors and one or more non-image sensors. The vehicle sensors 204, 206 may be image capture devices (such as cameras), audio sensors, infrared sensors, radar, ultrasound sensors, electro-optics sensors, radiography sensors, Lidar (light detection and ranging) sensors, thermal sensor sensors, passive sensors, active sensors, etc. The plurality of sensed images may be received at a plurality of time intervals.

The ground vehicle 200 may also include one or more processing circuits 208, memory unit 210, communication unit 212, and one or more vehicle units 214 such as one or more vehicle computers, units controlled by the one or more vehicle units, motor units, chassis, wheels, and the like. The one or more processing circuits 208 are configured to execute the systems and methods disclosed herein.

According to an embodiment, the ground vehicle sensed images are 360-degree ground vehicle sensed images. In this instance, each ground vehicle sensed image covers a 360-degree sample of the environment of the ground vehicle. According to an embodiment, the ground vehicle sensed images cover less than 360 degrees. Including a broader coverage area in the ground vehicle sensed image may increase the accuracy of the location detection. Including a narrower coverage area in the ground vehicle sensed image may require less bandwidth and may therefore be less expensive to execute.

According to an embodiment, a sensed image is generated by acquiring a plurality of ground vehicle sensed images. The ground vehicle sensed images may be of different angular segments of a vehicle's field of view. The different angular segments may be acquired by different image sensors having different fields of views (differ by at least by their polar angle coverage), and/or may be acquired by scanning the environment of the ground vehicle—for example using movable image sensors or image sensors preceded by optics of an adjustable field of view. The plurality of ground vehicle sensed images may be captured in close-timing proximity (e.g., within a fraction of a second from each other). The plurality of ground vehicle sensed images, or at least a portion of the visual information contained therein, may then be stitched or otherwise combined to provide a 360-degree ground vehicle sensed images.

The sensed images and aerial images may be translated into image signatures, by for example, a processor (e.g., the cross-view localization module 102). An image signature of a detected region (e.g., a ground vehicle-sensed image or an aerial image) may be defined as information regarding one or more other regions of the image.

To generate the image signatures from sensed images and/or aerial images or image segments, the cross-view localization module 102 may include a ground encoder 120 and an aerial encoder 122. The ground encoder 120 is configured to extract a sensed image signature (e.g., a ground-vehicle image signature) from an image captured by a vehicle sensor. The sensed image signature contains ground image information of a captured image segment that is needed to perform a comparison between the image segment and at least one additional input (e.g., a satellite image). A plurality of sensed image signatures may be obtained at a plurality of time intervals.

The aerial encoder 122 extracts a plurality of aerial image signatures from, for example, received satellite images. Aerial image segment signatures are composed of information relating to aerial image segments of a region in which a vehicle may be located (i.e., the specified image capture area). Each aerial image signature includes information regarding the selected specified image capture area. Signatures of an aerial segment or a subsegment of an aerial segment (e.g., a segment patch) may be generated by applying a self-attention mechanism to the segment or the segment patch. A self-attention mechanism may be a mechanism that computes attention scores between patches, based, for example, on the content and position of an object in the image. The self-attention mechanism may be included in a transformer neural network.

The cross-view localization module 102 is also configured to match an aerial image segment signature of the plurality of aerial image segment signatures to a sensed image signature of the plurality of sensed image signatures. As shown in FIG. 1C, a process for matching a sensed (ground) image signature to an aerial image signature is shown. Prior to input into the cross-view localization module 102, the ground view image and the aerial image may be divided into one or more sections or a grid. Once an image is input into the cross-view localization module 102, in, for instance, a grid formed from individual image segments, a linear projection of the one or more grid segments may be calculated. A ground view image class embedding and position embedding, as well as a plurality of ground position and patch embeddings may be created from the linear projection. Similarly, an aerial image class and position embedding, and a plurality of aerial position and patch embeddings may be created from the linear projection.

The respective class/position embeddings and position/patch embeddings may be fed into the ground encoder 120 and the aerial encoder 122, respectively. In such instances, the ground encoder 120 and the aerial encoder 122 may be Vision Transformer (ViT) encoders or may leverage another like deep learning architecture. The output of the ground encoder 120 may be a ground image class token and a plurality of ground image patch tokens. The output of the aerial encoder 122 may be an aerial image class token and a plurality of aerial image patch tokens. A multi-layer perceptron function may be performed on the ground encoder class token and the plurality of aerial patch tokens.

The system is trained with attention mechanisms to locate the best representations and matching between aerial image signatures and sensed image signatures. For instance, the cross-view localization module 102 may apply a contrastive loss function to the input tokens. In such instances, the training process may include feeding the machine learning process with ground vehicle sensed images at different points in time and corresponding aerial images. The training process may cause the machine learning process to provide a mapping between the vehicle sensed image signatures and the aerial image segment signatures. The training process may also induce training the machine learning process to (i) provide a similar signature to a ground vehicle sensed image of a region and an aerial image segment signature of that region, and (ii) provide dissimilar signatures to a ground vehicle sensed image and an aerial image segment of different regions. In some instances, the training process relies on a neural network such as an attention mechanism. Other functions configured to determine how well a model can differentiate between similar and dissimilar data points may be utilized.

During an inference phase, a cosine similarity function may be applied. Other functions configured to a measure of similarity between two non-one vectors defined in an inner product space may be utilized.

Probabilistic location information is then generated from the processing steps performed by the cross-view localization module 102. For instance, the cross-view localization module 102 is further configured to generate probabilistic location information (e.g., a probability map) regarding the location of the vehicle during the plurality of time intervals. The probabilistic location information is based on the matching of the aerial image segment signature and the sensed image signature. For example, the sensed image signature and the aerial image signature are compared against each other to create probabilistic location information. As mentioned above, the aerial image signatures input into the cross-view localization module 102 may be constructed during training such that they contain relevant data from other patches of the satellite image. This may be executed by utilizing a self-attention mechanism, i.e., a mechanism that computes attention scored between patches, based, for example, on content and position in the image. Determining a probabilistic location of the ground vehicle includes determining the location information at a sub-patch resolution. A sub-patch refinement module may be applied to accurately estimate the location of the camera in the satellite image. For instance, with respect to a received satellite patch, one or more satellite patch neighbors may be fused to indicate where inside the patch the location probability is the highest. Alternatively, up-sampling (i.e., using an up-sampled version of the aerial image) may be utilized on the satellite image.

According to an embodiment, the probabilistic location information is a heatmap. A color of a heatmap pixel is indicative of a probability that the vehicle is located at the heatmap pixel. For instance, a high concentration of red pixels may indicate a high location probability.

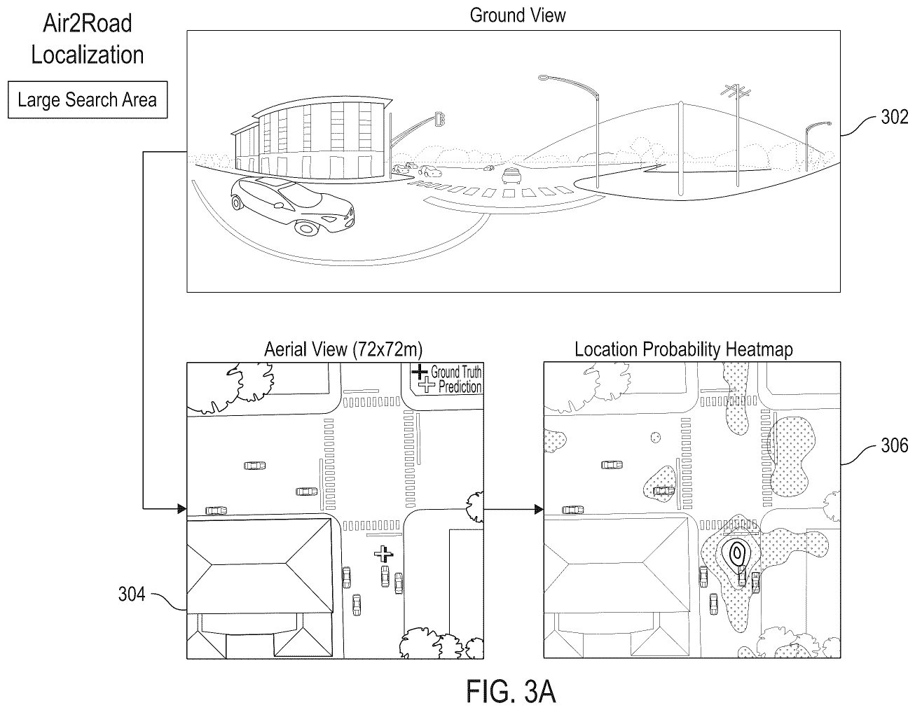

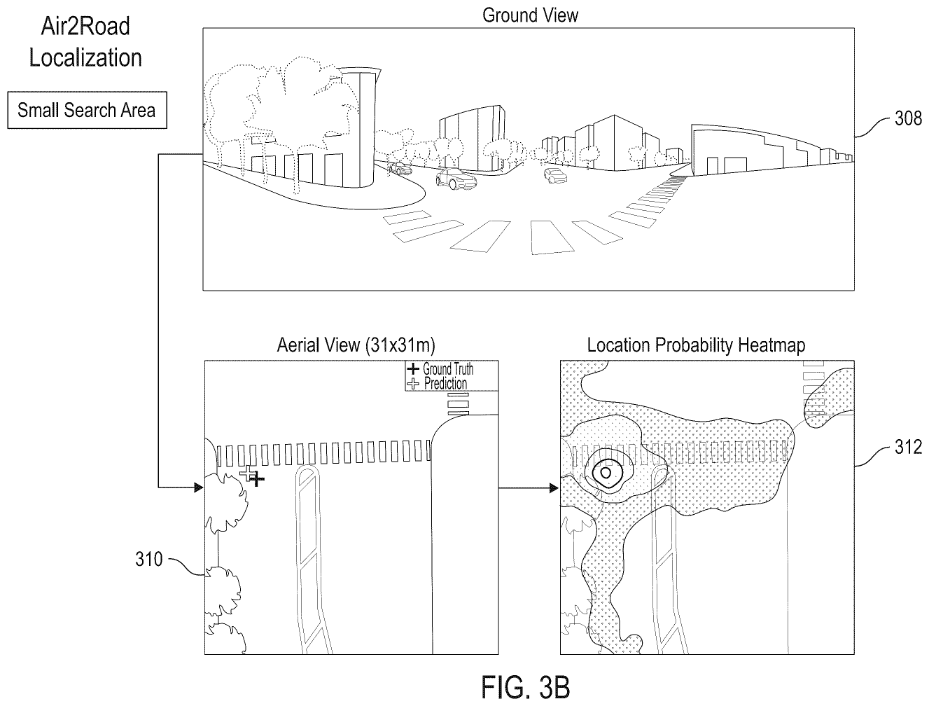

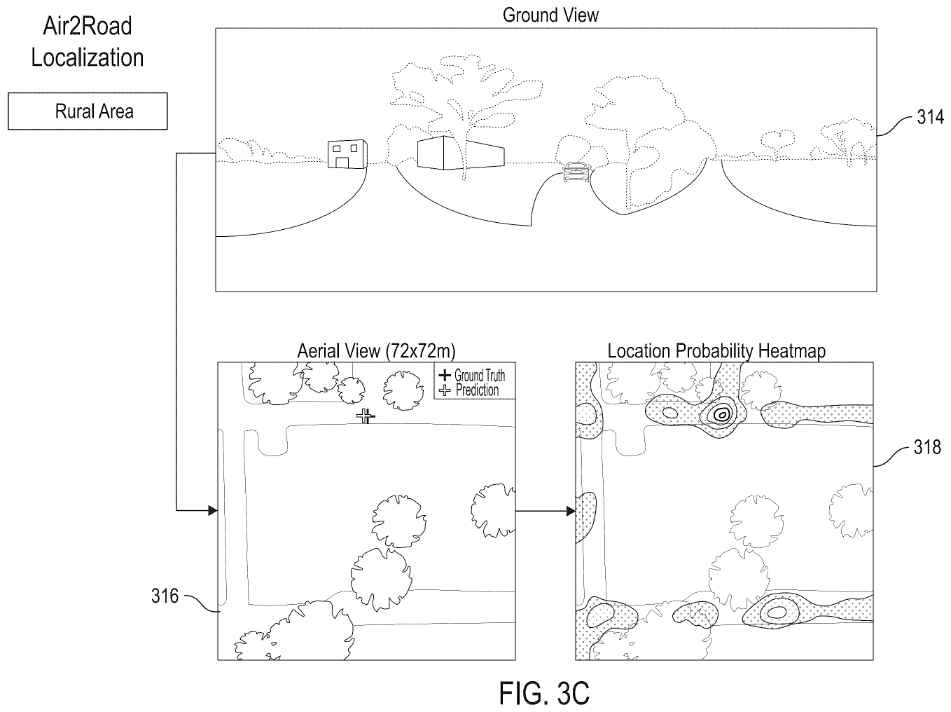

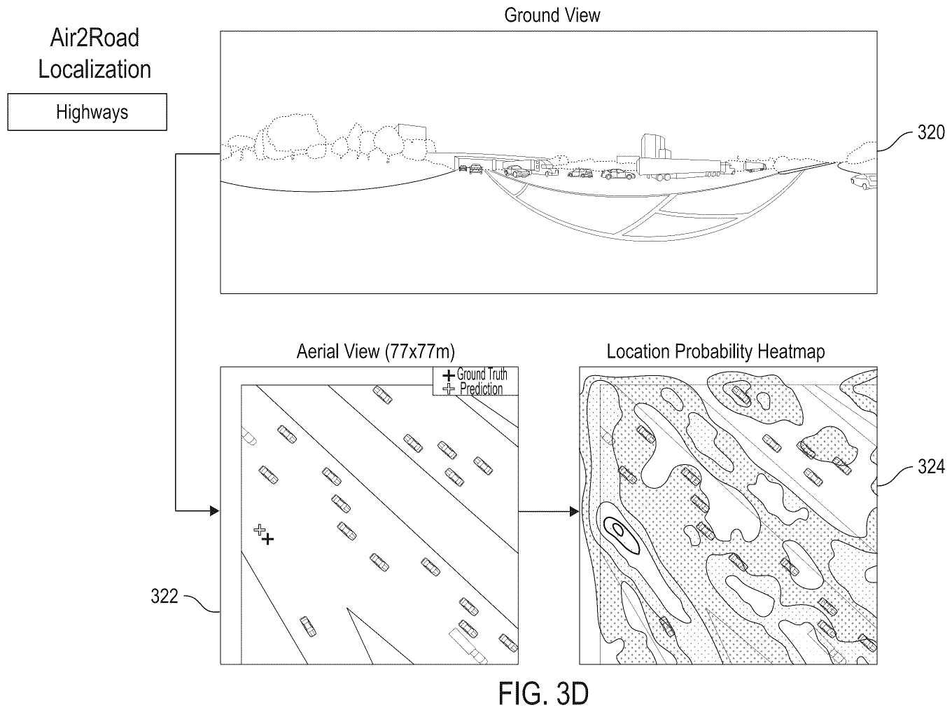

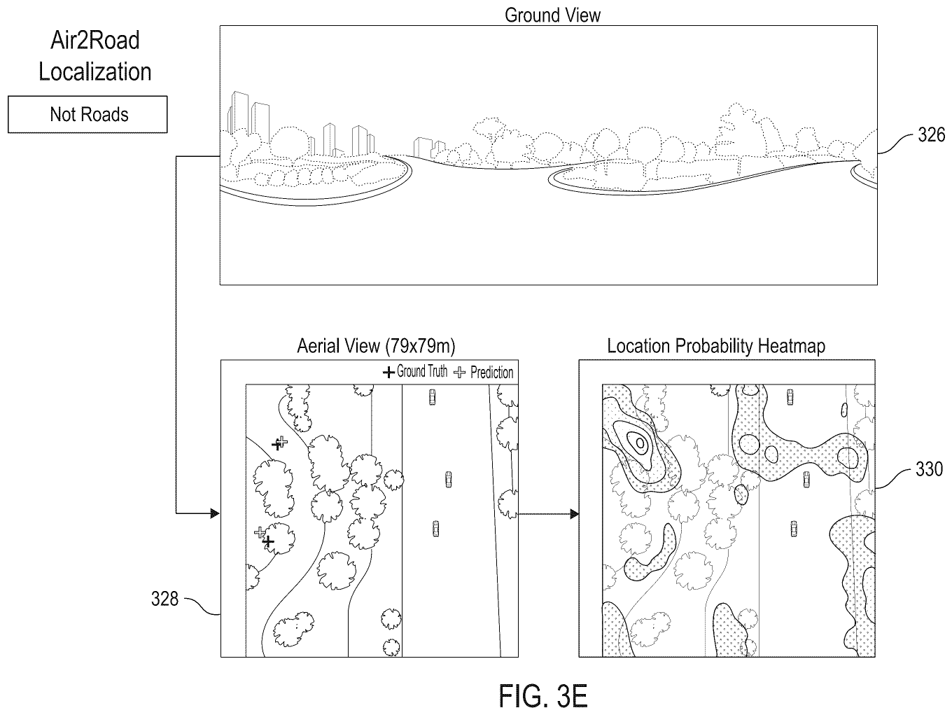

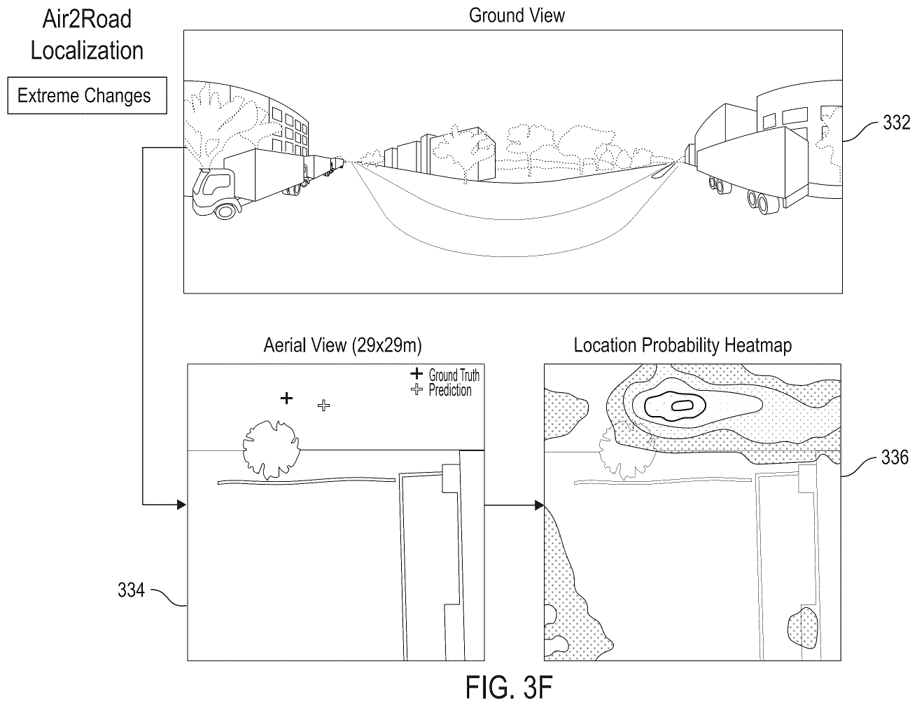

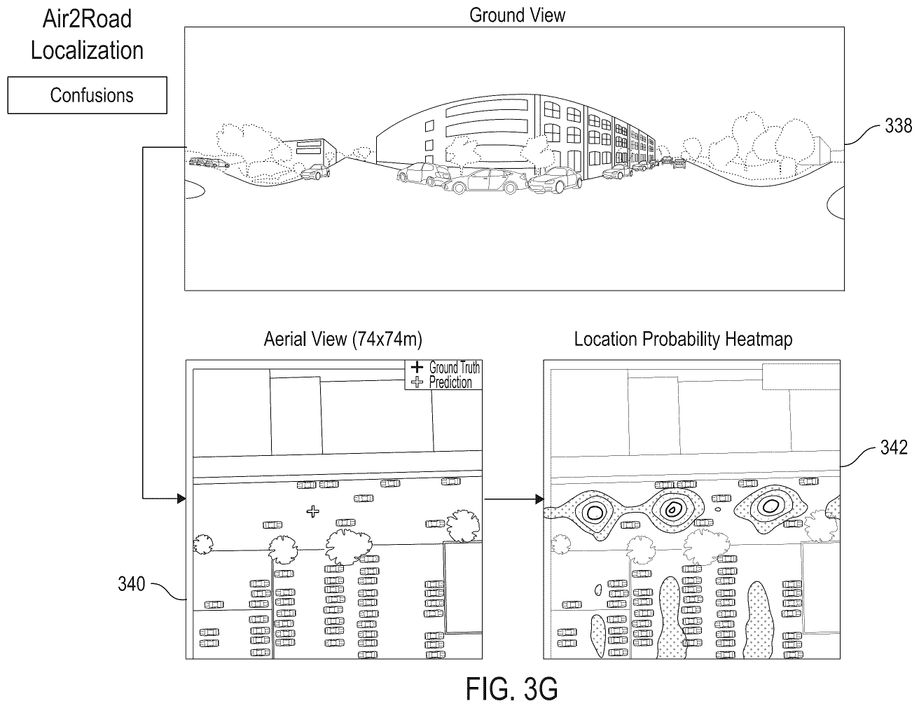

FIGS. 3A-3G illustrate examples of an aerial image segments, a vehicle image segments, and corresponding heatmaps according to embodiments of the disclosure. The system 100 is configured to adapt to any number of driving scenarios. Modifications to the sensed and aerial image inputs may be made based on the environment as determined by one or more onboard vehicle sensors. FIG. 3A illustrates an example of a vehicle image segment 302, an aerial image segment 304, and corresponding heatmap 306 for a vehicle in a large search area. For example, a large search area may be defined as approximately 74 m×74 m or greater. FIG. 3B illustrates an example of a vehicle image segment 308, an aerial image segment 310, and corresponding heatmap 312 for a vehicle in a small search area. For example, a small search area may be defined as approximately 29 m×29 m or greater. FIG. 3C illustrates an example of a vehicle image segment 314, an aerial image segment 316, and corresponding heatmap 318 for a vehicle in a rural area. FIG. 3D illustrates an example of a vehicle image segment 320, an aerial image segment 322, and corresponding heatmap 324 for a vehicle in a highway scenario. FIG. 3E illustrates an example of a vehicle image segment 326, an aerial image segment 328, and corresponding heatmap 330 for a vehicle in a side-road scenario. FIG. 3F illustrates an example of a vehicle image segment 332, an aerial image segment 334, and corresponding heatmap 336 for a vehicle in a scenario involving an extreme change in vehicle direction. FIG. 3G illustrates an example of a vehicle image segment 302, an aerial image segment 304, and corresponding heatmap 306 for a vehicle in a large search area.

The system is further configured to obtain a movement estimate of the vehicle during the plurality of time intervals. In some embodiments, the movement estimate may be obtained from the visual odometry module 104. For example, the visual odometry module 104 may be configured to analyze a plurality of sensed images received from a vehicle sensor (e.g., one or more of sensors 204, 206). The movement estimate is generated based on a vehicle location comparison across the plurality of sensed images. For instance, the visual odometry module 104 may detect an object in a first received image. The visual odometry module 104 may then search for the object in subsequent images and calculate or estimate vehicle movement information from the differences in position of the detected object. The object may be stationary to allow for a comparison of the vehicle in motion to the object at discrete time intervals. In some embodiments, velocity information may be extracted from controller area network (CAN) signals. The visual odometry module 104 may then use the received inputs to update vehicle location as the vehicle traverses a path.

According to an embodiment, motion information may be gained from non-image sensors of the ground vehicle. The system may further comprise a sensor module 106 configured to receive inputs from a plurality of sensors (examples of which are described above in FIG. 2). The motion information may therefore be obtained by at least one sensor, such as a vehicle direction or propagation sensor (e.g., a sensor configured to determine the direction of propagation of the vehicle), an accelerometer, and the like. Sensor module information may be combined with the cross-view localization module output and/or the visual odometry output.

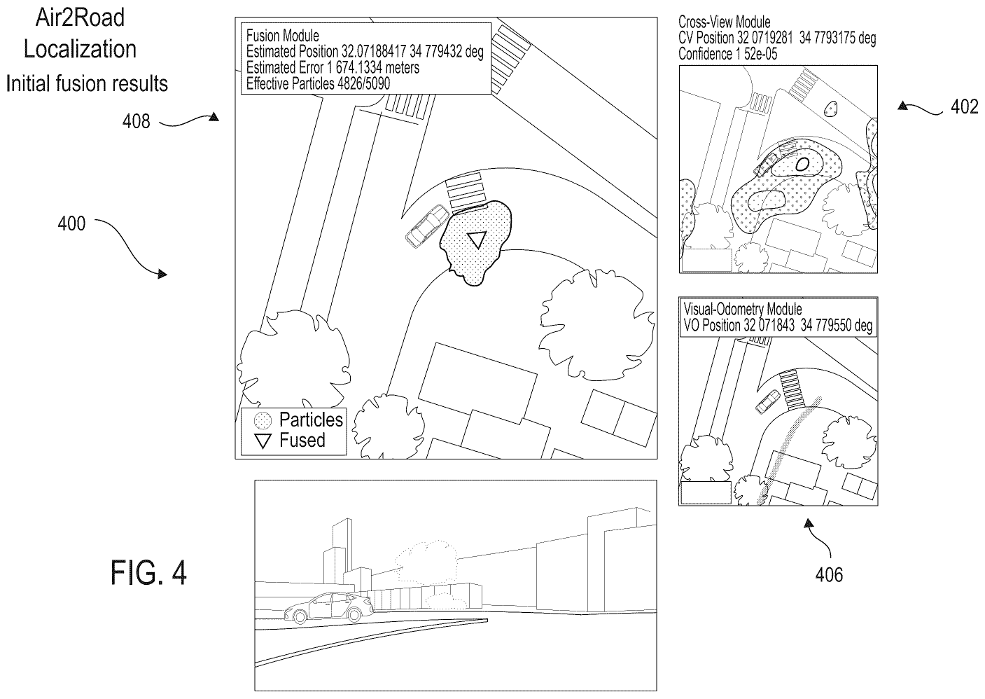

The system 100 is further configured to determine the location of the vehicle by fusing or combining the movement estimate of the vehicle and the probabilistic location information. For instance, the fusion module 108 may combine or fuse input location information. The fusion module 108 may be a particle filter, such as a Bayes filter or a Kalman filter. FIG. 4 illustrates initial fusion results, whereby a heatmap 402 from the cross-view localization module 102 and movement information 404 from the visual odometry module are fused or combined to form a fusion module depiction 406 of a vehicle location. Determining the location of the ground vehicle may be based on, or solely on, a combination or fusing of the movement estimate of the ground vehicle, the probabilistic location information and coarse ground vehicle location information. Alternatively, determining the location of the ground vehicle may be based on, or solely on, a combination or fusing of the movement estimate of the ground vehicle, the probabilistic location information and motion information gained from non-image sensors of the ground vehicle. Determining the location of the ground vehicle may be based on, or solely on, a combination or fusing of the movement estimate of the ground vehicle, the probabilistic location information, motion information gained from non-image sensors of the ground vehicle and coarse ground vehicle location information.

According to an embodiment, the fusing is executed by a machine learning process of the fusion module, the machine learning process has undergone a training process in which it learns to fuse outputs from the cross-view localization module and the visual odometry module.

Determining the location of the ground vehicle may further include triggering a determination of an autonomous driving operation. Thus, the determining the location of the ground vehicle may further include determining the autonomous driving operation, and/or executing the autonomous driving operation. According to embodiments of the disclosure, the autonomous driving operation includes at least one of autonomously controlling a speed and/or direction of propagation and/or acceleration of a vehicle. The autonomous driving operation may also be an emergency breaking operation, a lane maintaining driving operation, a lane changing driving operation, and the like.

A resultant location indication may be accurate to a sub-10 cm offset. The system is able to perform vehicle localization in any location without the need for the particular road to have been driven by the vehicle previously. The system 100 may be configured to execute offline, by leveraging highly compressed aerial image signatures stored in the system.

FIG. 5 illustrates an example of a method 500 for determining a location of a ground vehicle. The method may be executed by the system 100, or any components thereof e.g., the cross-view module 102, the visual odometry module 104, the sensor module 106, and the fusion module 108 of the system 100 as described herein. The method 500 includes obtaining 502, by a processor, a plurality of aerial image segment signatures of segments of a region including the vehicle. The method also includes obtaining 504, by the processor, a plurality of sensed image signatures associated with the region including the vehicle. The method also includes matching 506, by the processor, a selected aerial image segment signature of the plurality of aerial image segment signatures to a selected sensed image signature of the plurality of sensed image signatures. The method further includes, based on the matching, generating 508, generating, by the processor, probabilistic location information regarding the location of the vehicle. According to an embodiment, the generating of the probabilistic location information comprises applying a random sample consensus process. The probabilistic location information may be generated per pixel (i.e., is pixelwise) or per a group of any number of pixels. The probabilistic location information is a heatmap. A color of a heatmap pixel is indicative of a probability that the vehicle is located at the heatmap pixel.

The method further includes generating 510, by the processor, a movement estimate of the vehicles, wherein the movement estimate is generated based on a vehicle location comparison across a plurality of vehicle sensed images, wherein the plurality of vehicle sensed images are captured at a plurality of time intervals. The method also includes determining 512, by the processor, the location of the vehicle by combining the movement estimate of the vehicle and the probabilistic location information.

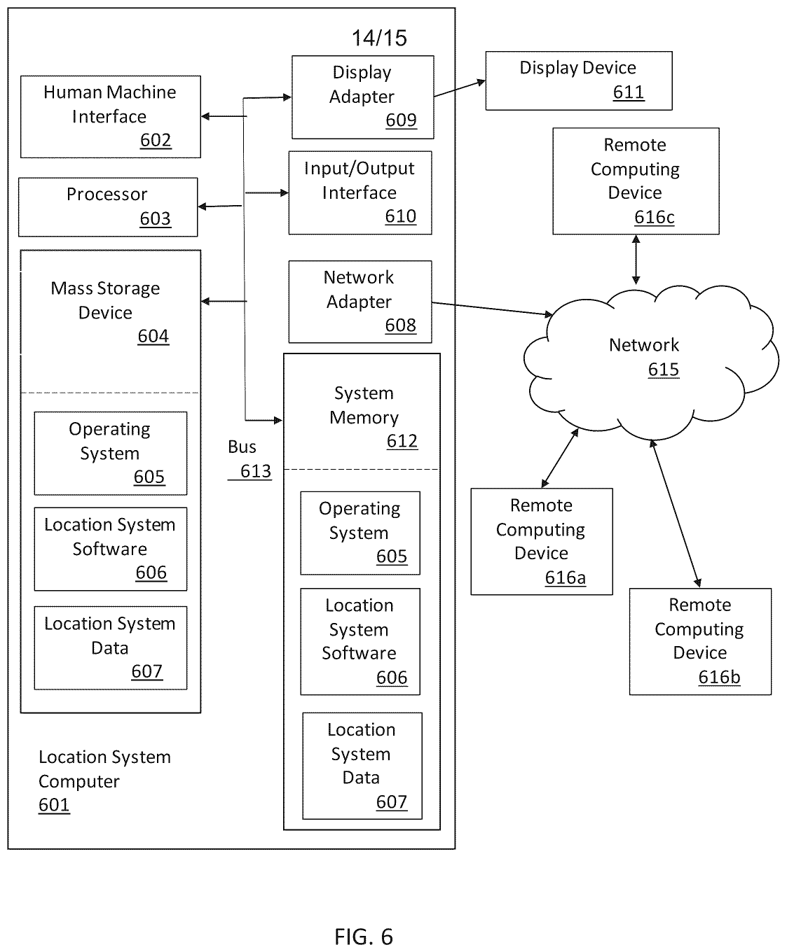

FIG. 6 is a block diagram illustrating an exemplary operating environment for performing at least a portion of disclosed methods according to an embodiment of the present invention. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

Further, one skilled in the art will appreciate that the systems and methods disclosed herein can utilize a specialized computing device in the form of a location system computer 601 (which may be included in, for example location system 100). The methods discussed above can be performed by the computer 601. For example, the computer 601 can perform the duties and responsibilities discussed above.

The components of the location system computer 601 can comprise, but are not limited to, one or more processors or processing units 603, a system memory 612, and a system bus 613 that couples various system components including the processor 603 to the system memory 612. In the case of multiple processing units 603, the system can utilize parallel computing.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the processor 603, a mass storage device 604, an operating system 605, location system software 606, location system data 607, a network adapter 608, system memory 612, an Input/Output Interface 610, a display adapter 609, a display device 611, and a human machine interface 602, can be contained within one or more remote computing devices 614 a,b,c at physically separate locations, connected through buses of this form, in effect implementing a fully distributed system.

The location system computer 601 typically comprises a variety of computer readable media. Exemplary readable media can be any available media that is accessible by the location system computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as location system data 607 and/or program modules such as operating system 605 and location system software 606 (i.e., modules and the like that perform the methods discussed above) that are immediately accessible to and/or are presently operated on by the processing unit 603.

In another aspect, the location system computer 601 can also comprise other removable/non-removable, volatile/non-volatile computer storage media. By way of example, FIG. 11 illustrates a mass storage device 604, which can provide non-volatile storage of computer code, computer readable instructions, data structures, program modules, and other data for the location system computer 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and location system software 606. Each of the operating system 605 and location system software 606 (or some combination thereof) can comprise elements of the programming and the location system software 606. location system data 607 can also be stored on the mass storage device 604. location system data 607 can be stored in any of one or more databases known in the art. Examples of such databases include DB2®, Microsoft® Access, Microsoft® SQL Server, Oracle®, mySQL, PostgreSQL, and the like. The databases can be centralized or distributed across multiple systems. In other aspects, the location system data 607 can be stored on the mass storage device 605 of other servers or devices (e.g., remote computing device 614 a,b,c) in communication with the location system computer 601.

In another aspect, the user can enter commands and information into the location system computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the location system computer 601 can have more than one display adapter 609 and more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like.

The location system computer 601 can operate in a networked environment using logical connections to one or more remote computing devices 614 a, b, c. By way of example, a remote computing device can be a personal computer, a laptop computer, portable computer, a server, a router, a network computer, a peer device or other common network node, and so on. Logical connections between the location system computer 601 and a remote computing device 614 a, b, c can be made via a local area network (LAN) and a general wide area network (WAN). Such network connections can be through a network adapter 608. A network adapter 608 can be implemented in both wired and wireless environments. Such networking environments are conventional and commonplace in offices, enterprise-wide computer networks, intranets, and a network 615 such as the internet 615.

For purposes of illustration, application programs and other executable program components such as the operating system 605 are illustrated herein as discrete blocks, although it is recognized that such programs and components reside at various times in different storage components of the location system computer 601, and are executed by the data processor(s) of the computer. An implementation of location system software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing circuits described herein may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. In the embodiments described herein, the illustrated examples may be implemented as circuitry located on a single integrated circuit or within a same device. Alternatively, the examples may be implemented as any number of separate integrated circuits or separate devices interconnected with each other in a suitable manner.

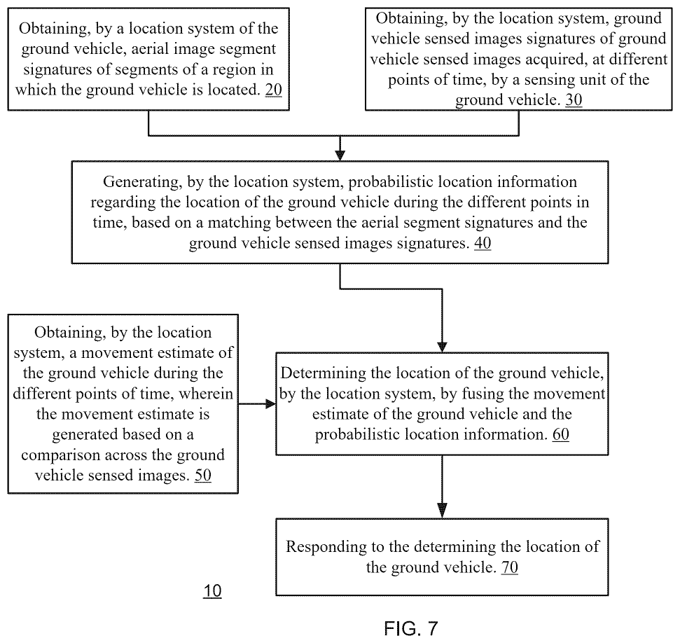

FIG. 7 illustrates an example of a method 10 for determining a location of a ground vehicle.

According to an embodiment, method 10 includes steps 20 and 30.

According to an embodiment, step 20 includes obtaining, by a location system of the ground vehicle, aerial image segment signatures of segments of a region in which the ground vehicle is located.

According to an embodiment, the ground vehicle sensed images are 360-degree ground vehicle sensed images. In this case, each ground vehicle sensed image covers a 360-degree sample of the environment of the ground vehicle.

According to an embodiment, the ground vehicle sensed images cover less than 360 degrees. A broader coverage may increase the accuracy of the location detection—but a lower coverage may be less costly to sense.

The required coverage may be determined in advance or in a dynamic manner. For example—assuming that the ground vehicle is located in an urban area or another area that exhibits a high density of objects—then the coverage may be reduced. On the other hand—assuming that the ground vehicle is located in a desolate area—or other area with sparse objects—then the coverage may be increased. The amendment of the coverage may be assisted by coarse location information of the ground vehicle—such as a global positioning satellite (GPS) location information, cellular cell location information, and the like.

According to an embodiment, a ground vehicle sensed image is generated by acquiring (in close timing proximity—for example within a fraction of a second) a plurality of ground vehicle sensed images of different angular segments—and stitching or otherwise combining the visual information to provide a 360-degree ground vehicle sensed images. The plurality of ground vehicle sensed images of different angular segments may be acquired by different image sensors of different fields of views (differ by at least by their polar angle coverage), and/or may be acquired by scanning the environment of the ground vehicle—for example using movable image sensors or image sensors preceded by optics of an adjustable field of view.

According to an embodiment, method 10 includes step 30 of obtaining, by the location system, ground vehicle sensed images signatures of ground vehicle sensed images acquired, at different points of time, by a sensing unit of the ground vehicle.

According to an embodiment, steps 20 and 30 are followed by step 40 of generating, by the location system, probabilistic location information regarding the location of the ground vehicle during the different points in time, based on a matching between the aerial segment signatures and the ground vehicle sensed images signatures.

According to an embodiment, the generating of the probabilistic location information comprises applying a random sample consensus process.

According to an embodiment, the probabilistic location information is provided per pixel (is a pixelwise—or per a group of pixels of any number of pixels.

According to an embodiment, the probabilistic location information is a heatmap. A color of a heatmap pixel is indicative of a probability that the vehicle is located at the heatmap pixel.

According to an embodiment, method 10 includes step 50 of obtaining, by the location system, a movement estimate of the ground vehicle during the different points of time, wherein the movement estimate is generated based on a comparison across the ground vehicle sensed images.

According to an embodiment, steps 40 and 50 are followed by step 60 of determining the location of the ground vehicle, by the location system, by fusing the movement estimate of the ground vehicle and the probabilistic location information.

According to an embodiment, step 60 includes processing the aerial image segment signatures with the vehicle sensed images signatures, by fusing the obtained movement estimate of the vehicle with the probabilistic location information, for determining the location of the vehicle.

According to an embodiment, step 60 is also responsive to motion information gained from non-image sensors of the ground vehicle. This motion information may be obtained by at least one sensor such as a vehicle direction or propagation sensor (determining the direction of propagation of the vehicle), an accelerometer, and the like.

According to an embodiment, step 60 may be based solely on the movement estimate of the ground vehicle, the probabilistic location information and coarse ground vehicle location information.

According to an embodiment, step 60 may be based solely on the movement estimate of the ground vehicle, the probabilistic location information and motion information gained from non-image sensors of the ground vehicle.

According to an embodiment, step 60 may be based solely on the movement estimate of the ground vehicle, the probabilistic location information, motion information gained from non-image sensors of the ground vehicle and coarse ground vehicle location information.

According to an embodiment step 60 determines the location information at a sub-path resolution. This is done, for example, in one of several ways, like fusing the neighbors of a patch to indicate where inside this patch the probability is the highest and/or using an up-sampled version of the aerial image.

A region of the aerial image may be of any shape and/or size and/or may have an area that ranges between 0.1 till 20 percent of an overall size of the area covered by the aerial image.

According to an embodiment, the fusing is executed by a machine learning process that undergone a training process.

According to an embodiment, the training process included feeding the machine learning process with ground vehicle sensed images and corresponding aerial images and inducing the machine learning process to (i) provide a similar signature to a ground vehicle sensed image of a region and an aerial image segment signature of that region, and (ii) provide dissimilar signatures to a ground vehicle sensed image and an aerial image segment of different regions.

According to an embodiment, the machine learning process exhibits a transformer architecture and the including includes applying an attention mechanism.

According to an embodiment, a signature of a region (being a ground vehicle sensed image or an aerial image) includes information regarding one or more other regions of the image.

According to an embodiment, the signatures of the segment or the patch is generated by applying self-attention mechanism—that computes attention scored between patches-based (for example, on content and position in the image.

According to an embodiment, the training process included feeding the machine learning process with ground vehicle sensed image signatures sensed at different point in time and corresponding aerial image segment signatures and causing the machine learning process to provide a mapping between the ground vehicle sensed image signatures and the aerial image segment signatures.

According to an embodiment, step 60 is followed by step 70 of responding to the determining the location of the ground vehicle.

Step 70 may include at least one of:
Triggering a determination of an at least partially autonomous driving operation. According to an embodiment, the at least partially autonomous driving operation is a fully autonomous driving operation or is only a partially autonomous driving operation such as an ADAS driving operation. According to an embodiment, the at least partially autonomous driving operation includes at least one of autonomously controlling a speed and/or direction of propagation and/or acceleration of a vehicle. According to an embodiment, the at least partially autonomous driving operation is selected out of an emergency breaking, a lane maintaining driving operation, and the like.
Determining of an at least partially autonomous driving operation.
Executing an at least partially autonomous driving operation.

According to an embodiment, a data layer may be updated based on the location of the vehicle.

The data layer may be defined by any entity and/or in any manner—for example—by a user of the vehicle, by a vehicle manufacturer, by any vendor or manufacturer of any one or (i) software related to the vehicle, (ii) hardware related to the vehicle, and the like.

The data layer may be a narrow data layer in the sense that it includes information regarding road elements of one or more specified types—for example of road signs, traffic lights, lanes, trees, fences, one or more static road elements, one or more movable road elements, lanes edges, road edges, traffic signs, road markings, speed per lane and the like. According to an embodiment, the one or more specified types may be up to 0.5, 1, 5, 10, 15, 20 percent of road elements that are seen at a certain location or at a certain city or at a certain county or at a certain country, and the like.

Using a data layer that is narrow reduces the number of resources required to generate and/or update and/or transmit the data layer.

The data layer may be used for various purposes—for example—verifying, debugging, analyzing, monitoring the operations of one or more software and/or hardware components, preparing (for example-adjusting a driving parameter to achieve a desired comfort level) for a curve, or a right turn, or a highway exit, etc.

The data layer may store information about the one or more specified types in any format and/or in any manner-a database, a file, in a compressed form, in an encrypted form, in an access controlled manner, and the like.

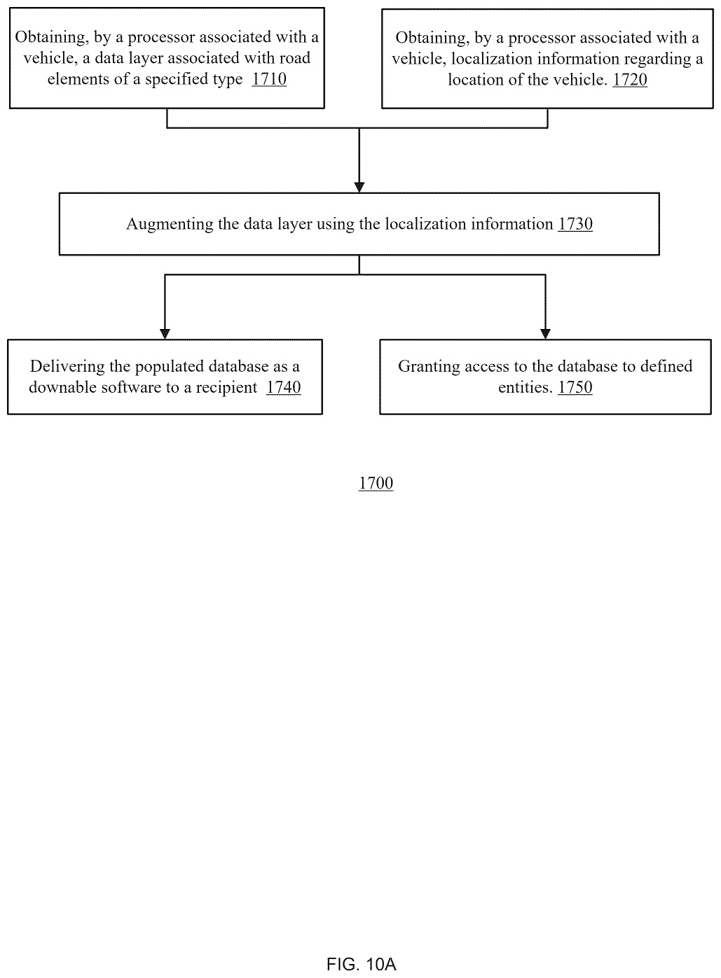

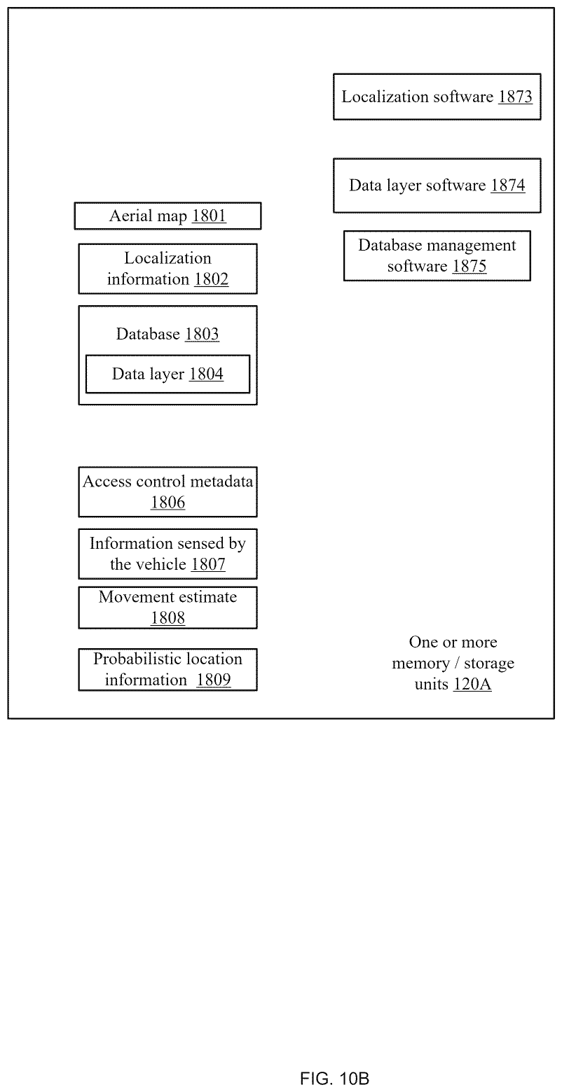

FIG. 10A illustrates an example of method 1700 that is computer implemented and is for data layer augmentation.

According to an embodiment, method 1700 included step 1710 of obtaining, by a processor associated with a vehicle, a data layer associated with road elements of a specified type.

According to an embodiment, method 1700 also includes step 1720 of obtaining, by a processor associated with a vehicle, localization information regarding a location of the vehicle. The road element information is obtained based on aerial image information within a region of a vehicle and on environmental information sensed by the vehicle. Examples related to the localization information are illustrated in FIGS. 1C, and 3A-5.

According to an embodiment steps 1710 and 1720 are followed by step 1730 of augmenting the data layer using the localization information, wherein the augmenting of the data layer includes populating a database with data representing updated road elements location for a group of road elements of the specified type within the region of the vehicle.

According to an embodiment, the augmenting comprises adding one or more road elements that were absent from the data layer, deleting one or more road elements that were previously include in the data layer and/or changing a location of one or more road elements that associated with incorrect locations within the data layer.

According to an embodiment, the group of road elements are relevant to a driving path of the vehicle. According to an embodiment, method 1700 includes ignoring road elements that are outside the path (at least within a defined distance from the path).

According to an embodiment the aerial map is much richer than the data layer—as it is not limited to road elements of a specified type.

According to an embodiment, the road information is obtained based on a mapping between aerial image information signatures and environmental signatures. Examples related to the mapping are illustrated in FIG. 8C and other figures.

According to an embodiment, the augmenting involves updating data layer signatures. A data layer signature is a signatures that represents a road element of the specified type.

According to an embodiment, the localization information is based on a movement estimate of a road vehicle and on probabilistic location information indicative a location of the road vehicle within the aerial map. Examples of the movement estimate and of the probabilistic location information are illustrated in FIGS. 1A-1C, 2, 3A-3G, and 5—(for example—the visual odometry module 104, the probability map, probabilistic location information 228, motion information 226, localization probability heatmaps 308, 312, 318, 324, 330, 336, 342).

According to an embodiment, the road element information is based on a sub-lane resolution determination of the location of the vehicle.

According to an embodiment, method 1700 includes step 1740 of delivering the populated database as a downable software to a recipient. According to an embodiment, the recipient is the entity that defined the specified type of road elements to be represented in theor an entity that did not define the specified type.

According to an embodiment, the database is stored within a memory unit of the vehicle.

According to an embodiment, the database is access controlled and method 1700 includes step 1750 of granting access to the database to defined entities. The defined entities may include the entity that defined the specified type of road elements to be represented in the—and/or may include or an entity that did not define the specified type.

FIG. 10B illustrates an example of content (software and/or information) stored in one or more storage/memory units 120A for use in implementing method 1700.

The content may include at least one of:
Aerial map 1801.
Localization information 1802 indicative of at least one of a location of a vehicle and/or locations of road elements of (at least) a specific type.
Database 1803 that includes data layer 1804 that includes information regarding includes information regarding road elements of one or more specified types. The information includes at least the locations of the road elements.
Access control metadata 1806 for controlling access to the data layer.
Movement estimate 1806 for storing information about a movement of the vehicle.
Probabilistic location information 1809 indicative a location of the road vehicle within the aerial map. Examples of the movement estimate 1808 and of the probabilistic location information 1809 are illustrated in FIGS. 1A-1C, 2, 3A-3G, and 5—(for example—the visual odometry module 104, the probability map, probabilistic location information 228, motion information 226, localization probability heatmaps 308, 312, 318, 324, 330, 336, 342).
Localization software 1873 configured to generate localization information indicative of the location of (at least) the vehicle and road elements.
Data layer software 1874 configured to generate and update the data layer.
Database management software 1875 configured to control the generation and maintenance of database 1803.

There is provided a method for determining a location of a vehicle, the method includes: (i) obtaining, by a location circuit of the vehicle, aerial image segment signatures of segments of a region in which the vehicle is located; (ii) obtaining, by the location circuit, vehicle sensed images signatures of vehicle sensed images acquired, at different points of time, by a sensing unit of the vehicle; (iii) generating, by the location circuit, probabilistic location information regarding the location of the vehicle during the different points in time, based on a matching between the aerial segment signatures and the vehicle sensed images signatures; (iv) obtaining, by the location circuit, a movement estimate of the vehicle during the different points of time, wherein the movement estimate is generated based on a comparison across the vehicle sensed images; and (iv) processing the aerial image segment signatures with the vehicle sensed images signatures, by fusing the obtained movement estimate of the vehicle with the probabilistic location information, for determining the location of the vehicle.

According to an embodiment, the vehicle sensed images are 360-degree vehicle sensed images.

According to an embodiment, the generating of the probabilistic location information includes applying a random sample consensus process.

According to an embodiment, the determining the location of the vehicle further is also responsive to motion information gained from non-image sensors of the vehicle.

According to an embodiment, the obtaining of the aerial image segment signatures of segments of the region in which the vehicle is located is based on coarse vehicle location information.

According to an embodiment, the coarse vehicle location information is a global positioning system (GPS) vehicle location information.

According to an embodiment, the determining of the location of the vehicle is based solely on the movement estimate of the vehicle and the probabilistic location information.

According to an embodiment, the determining of the location of the vehicle is based solely on the movement estimate of the vehicle, the probabilistic location information and coarse vehicle location information.

According to an embodiment, the determining the location of the vehicle includes applying a Kalman filter on the movement estimate of the vehicle and on the probabilistic location information.

According to an embodiment, the determining the location of the vehicle includes applying a particle filter on the movement estimate of the vehicle and on the probabilistic location information.

According to an embodiment, the probabilistic location information is a heatmap.

According to an embodiment, the method includes sensing the vehicle sensed images by the sensing unit of the vehicle and generating the vehicle sensed images signatures.

There is provided a non-transitory computer readable medium for determining a location of a vehicle, the non-transitory computer readable medium stores instructions that once executed by a location system of the vehicle cause the location system to: (i) obtain aerial image segment signatures of segments of a region in which the vehicle is located; (ii) obtain vehicle sensed images signatures of vehicle sensed images acquired, at different points of time, by a sensing unit of the vehicle; (iii) generate probabilistic location information regarding the location of the vehicle during the different points in time, based on a matching between the aerial segment signatures and the vehicle sensed images signatures; (iv) obtain a movement estimate of the vehicle during the different points of time, wherein the movement estimate is generated based on a comparison across the vehicle sensed images; and (iv) process the aerial image segment signatures with the vehicle sensed images signatures, by fusing the obtained movement estimate of the vehicle with the probabilistic location information, for determining the location of the vehicle.

According to an embodiment, there is provided a system, a non-transitory computer readable medium and a method, the method includes producing the data layers (in real time, or offline)—producing data layers containing data layer information pertaining to ground truth road furniture (static road users objects including traffic lights; road markings; lane markings; road signs) by training a neural network on an aerial image (a).

According to an embodiment, this solution does not require to know the accurate location of the ego vehicle. Examples for data layers include lanes and road edges, traffic signs and traffic lights, road markings and speed per lane.

According to an embodiment, there is provided a system, a non-transitory computer readable medium and a method, the method includes updating a data layers (not an aerial image), actually the signatures of the data layers, with shared signature representation of the accurate location of the road objects.

The method may include augmenting a data layer application (not augmenting an aerial image of Google) with ground truth localization information

The method may include updating a data layer application (for example—by updating the signatures of the data layer) with sensed information ground truth objects signatures and using accurate localization information.

The updating of the data layer is especially useful when the frequency of the update of aerial images are not high. For example, the aerial images of Google, etc are usually updated once every couple of months.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim:

1. A method that is computer implemented and is for data layer augmentation, the method comprising:
obtaining, by a processor associated with a vehicle, a data layer associated with road elements of a specified type;
obtaining, by a processor associated with a vehicle, localization information regarding a location of the vehicle, wherein the road element information is obtained based on aerial image information within a region of a vehicle and on environmental information sensed by the vehicle; and
augmenting the data layer using the localization information, wherein the augmenting of the data layer comprises populating a database with data representing updated road elements location for a group of road elements of the specified type within the region of the vehicle.

2. The method of claim 1, wherein the data layer is a narrow data layer created in association with the specified type.

3. The method according to claim 1, wherein the road information are obtained based on a mapping between aerial image information signatures and environmental signatures.

4. The method according to claim 1, wherein the augmenting involves updating data layer signatures.

5. The method according to claim 1, wherein the localization information is based on a movement estimate of a road vehicle and on probabilistic location information indicative a location of the road vehicle within the aerial map.

6. The method according to claim 1, wherein the road element information is based on a sub-lane resolution determination of the location of the vehicle.

7. The method according to claim 1, wherein the augmenting comprises adding road elements that were absent from the data layer.

8. The method according to claim 1, wherein the group of road elements are relevant to a driving path of the vehicle.

9. The method according to claim 1, comprising delivering the populated database as a downable software to a recipient.

10. The method according to claim 1, wherein the database is stored within a memory unit of the vehicle.

11. The method according to claim 1, wherein the database is access controlled and wherein the method further comprises granting access to the database to defined entities.

12. A non-transitory computer readable medium for augmenting a data layer, the non-transitory computer readable medium stores instructions that once executed by a processor associated with a vehicle, causes the processor to:
obtain a data layer associated with road elements of a specified type;
obtain localization information regarding a location of the vehicle, wherein the road element information is obtained based on aerial image information within a region of a vehicle and on environmental information sensed by the vehicle; and
augment the data layer using the localization information, wherein the augmenting of the data layer comprises populating a database with data representing updated road elements location for a group of road elements of the specified type within the region of the vehicle.

13. The non-transitory computer readable medium according to claim 12, wherein the data layer is a narrow data layer created in association with the specified type.

14. The non-transitory computer readable medium according to claim 12, wherein the road information are obtained based on a mapping between aerial image information signatures and environmental signatures.

15. The non-transitory computer readable medium according to claim 12, wherein the augmenting involves updating data layer signatures.

16. The non-transitory computer readable medium according to claim 12, wherein the localization information is based on a movement estimate of a road vehicle and on probabilistic location information indicative a location of the road vehicle within the aerial map.

17. The non-transitory computer readable medium according to claim 12, wherein the road element information is based on a sub-lane resolution determination of the location of the vehicle.

18. The non-transitory computer readable medium according to claim 12, wherein the augmenting comprises adding road elements that were absent from the data layer.

19. The non-transitory computer readable medium according to claim 12, wherein the group of road elements are relevant to a driving path of the vehicle.

20. The non-transitory computer readable medium according to claim 12, wherein the database is access controlled and wherein the method further comprises granting access to the database to defined entities.
